(19) United States
(12) Patent Application Publication
(10) Pub. No.: US 2006/0015735 A1
(43) Pub. Date: Jan. 19, 2006

(54) Electronic watermarking method and storage medium for storing electronic watermarking program

(76) Inventors: Kei Kudo, Yokohama (JP); Mizuho Narimatsu, Yamato (JP); Isao Echizen, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/152,207

(22) Filed: Jun. 15, 2005

(30) Foreign Application Priority Data
Jun. 16, 2004 (JP) 2004-178041

(51) Int. Cl. H04L 9/00

(52) U.S. Cl. 713/176

(57) ABSTRACT

In embedding an electronic watermark in a plurality of frames making up video data, the filtering processing is executed by omitting a portion of the frames in terms of time or space. By using a result of the filtering processing, the electronic watermarking processing is executed on a portion that has undergone the filtering processing.

### INCORPORATION BY REFERENCE

The application claims the priority benefit of Japanese Patent Application No. 2004-178041 filed on Jun. 16, 2004, the entire descriptions of which are incorporated herein by reference.

### BACKGROUND OF THE INVENTION

The present invention relates to a watermarking technology and more particularly to a technology for embedding digital watermarks in video data.

An electronic watermarking technology is available as a tool for protecting a copyright of digital content. The electronic watermarking is a technique to embed in data, such as still images, video and sound, digital watermark information in such a way that it cannot be perceived by humans by taking advantage of characteristics of human perceptions. The electronic watermark information includes copyright information and user information. In a process of embedding digital watermarks into moving images, the digital watermark information is embedded in image frames themselves making up the video.

In embedding an electronic watermark in moving images, a conventional practice involves unconditionally executing electronic watermark embedding operation on all frames of the video and over an entire image area within the frames (all pixels). This process has a problem that it takes a massive volume of calculations and a huge processing time to embed the electronic watermark in the moving images. When it is attempted to reduce the time it takes to embed the electronic watermark in moving images using the conventional method, there is no alternative but to improve performance of hardware, a platform on which to execute the electronic watermarking processing. That is, CPU clock and hard disk drive (HDD) access performance must be improved, but building up hardware resources is costly. On platforms where significant hardware resource improvements cannot be expected, such as cell phones, there have been cases where even embedding electronic watermark information into moving images is not possible.

The processing of embedding electronic watermark into frames of video data can be described to be comprised roughly of luminance data extraction operation, filtering operation, and electronic watermark data embedding operation. The electronic watermark embedding is executed for each of noncompressed frames making up the video data. The luminance data extraction operation is performed in preparation for embedding electronic watermark and extracts luminance data from frames. The filtering operation is image processing performed as second preparatory processing prior to the electronic watermark data embedding operation. The electronic watermark data embedding operation embeds electronic watermark data in the image area of each frame based on values calculated by the filtering operation.

JP-A-2002-171494 discloses a technology for embedding electronic watermark into moving images. The technology described in Patent Document 1, after encoding, executes electronic watermark embedding operation on moving images. This technology assumes as a precondition the use of such formats as GOP and SH (sequence header) in MPEG and requires information on SH in performing the electronic watermark embedding operation.

### SUMMARY OF THE INVENTION

In the conventional technology, electronic watermarks are embedded in all frames of moving images and in an entire area of each frame, so there is a problem that the amount of calculations and the time required for processing are huge. To speed up the watermark embedding operation, there is no alternative but to improve the performance of the processing execution platform, which is costly. As for the technology disclosed in JP-A-2002-171494, since this technology requires information on SH in executing the electronic watermark embedding operation, object moving images to be watermarked are limited.

An object in the Detailed Description of the Embodiments is to realize at low cost an improved performance of processing to embed electronic watermarks in video data and a reduced processing time. Another object is to make it possible to realize processing of embedding electronic watermarks in moving image data on a platform with limited hardware resources.

In embedding electronic watermarks in frames making up video data, the filtering operation is executed on a plurality of frames by omitting a part of their time and space. Then, using a result of the filtering operation executed, the electronic watermark embedding operation is performed on those portions subjected to the filtering operation.

For example, an operation is performed to reuse calculated values obtained as a result of the filtering operation performed on past frames. A decision is made as to whether the filtering operation should be executed on a current frame, and not all of the frames are subjected to the filtering operation. The filtering operation is performed on those object frames that are determined to be subjected to the filtering operation and the result of the filtering operation performed is stored. For those frames not to be subjected to the filtering operation, the result of filtering operation on the past frames is read in for reuse. Alternatively, a frame type is checked to decide whether or not the electronic watermark embedding operation needs to be done for that particular frame. Or the electronic watermark embedding operation is performed on only a limited portion of an entire image of that frame.

### BRIEF DESCRIPTION OF THE DRAWINGS

The drawings show embodiments of this invention by way of example only according to a concept of the invention and are not intended to limit the invention. In the figures, like reference numbers refer to the same or identical elements.

FIG. 1 is an explanatory diagram showing an outline of example processing performed on video data in an electronic watermarking program.

FIG. 2 is a block diagram showing data input/output and an outline of processing.

FIG. 3 a flow chart showing an example of electronic watermarking processing.

FIG. 4 is a block diagram showing an example configuration of an electronic watermarking system.

FIG. 5 is an explanatory diagram showing an outline of another example of processing performed on video data.

FIG. 6 is a flow chart showing another example of electronic watermarking operation.

FIG. 7 is an explanatory diagram showing an outline of still another example of processing performed on video data.

FIG. 8 is a flow chart showing still another example of electronic watermarking operation.

### DETAILED DESCRIPTION OF THE EMBODIMENTS

Now embodiments of the present invention will be described in detail by referring to the accompanying drawings. Throughout all the drawings representing the embodiments, identical components are in principle assigned the same reference numbers and their repetitive explanations are omitted.

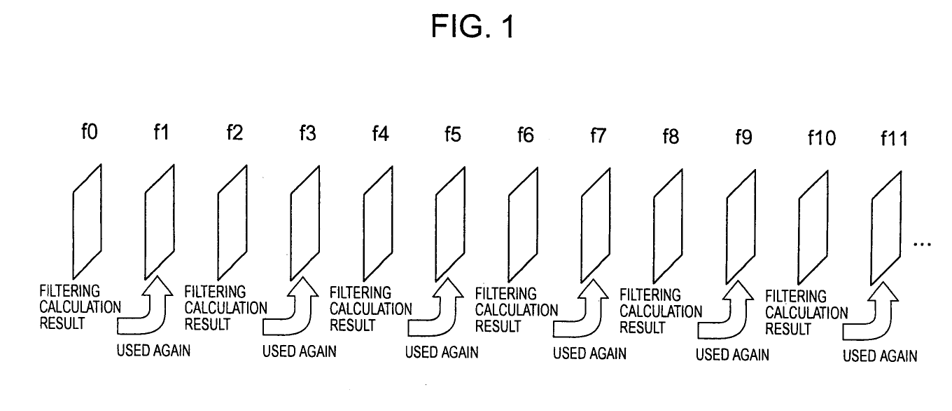

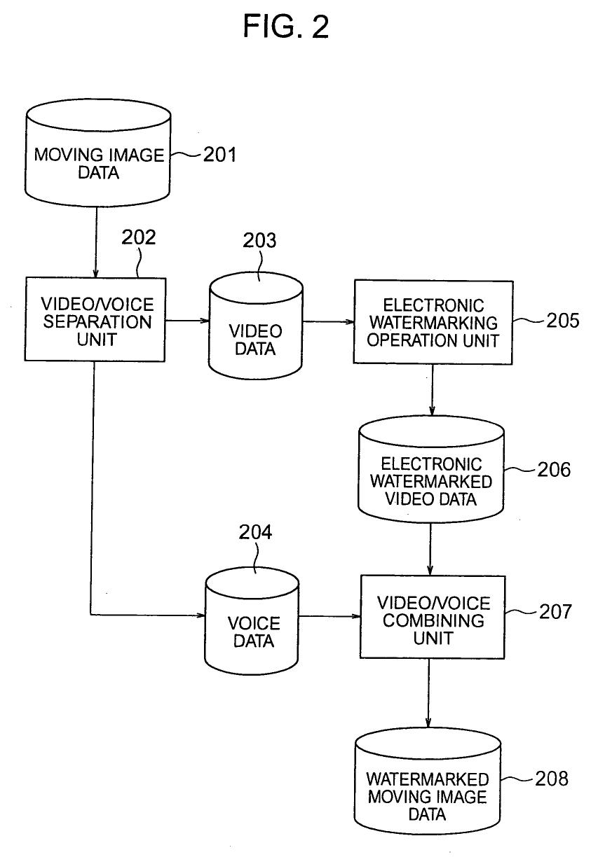

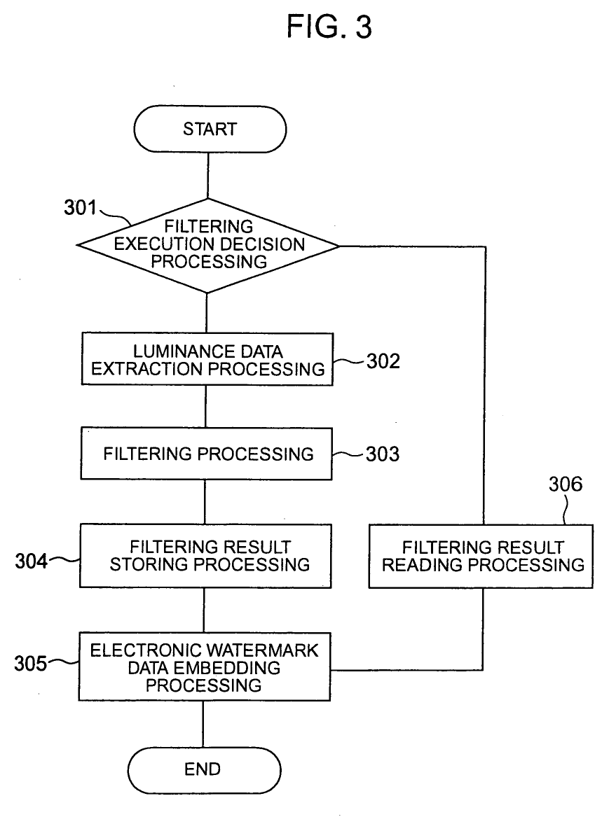

FIG. 1 is an explanatory diagram showing an outline of processing performed on video data by an electronic watermarking program in Embodiment 1 of this invention. FIG. 2 is a block diagram showing data input/output and an outline of processing associated with the electronic watermarking program in Embodiment 1 of this invention. FIG. 3 is a flow chart showing electronic watermarking operation performed by the electronic watermarking program in Embodiment 1 of this invention.

The electronic watermarking program of this embodiment is to input moving image data and embed an electronic watermark in the video data. This program causes the computer to execute a series of operations, which include: deciding whether or not to execute the filtering operation on frames making up the video data prior to the electronic watermarking operation; according to the filtering operation decision, executing an operation to set some of the frames making up the video data as non-target frames not to be subjected to the filtering operation; executing the filtering operation on those frames that have been decided to be target frames for the filtering operation and storing a result of this filtering operation; and reading in a result of the filter operation performed on past frames and reusing the result for those frames that have been decided to be the non-target frames for the filtering operation.

The decision takes advantage of the fact that a video data difference between image frames adjoining on time axis is small. Therefore, in executing the electronic watermarking operation on frames, i.e., executing processing including the filtering operation and the electronic watermark data embedding operation, a calculated value of the result of the filtering operation performed on a past frame which can be decided to have a small frame-to-frame difference is used again as is. For example, a target frame that is to be subjected to the filtering operation and a non-target frame that reuses the result of filtering operation on a frame, which is one frame before that target frame, are repetitively alternated.

In FIG. 1, reference numbers f0-f11 refer to frame numbers of image frames (hereinafter referred to simply as frames) consecutive on a time axis that make up video data. In Embodiment 1, in performing the electronic watermarking operation—processing including the filtering operation and the electronic watermark embedding operation—on a current frame of the frames making up the video data, a result of a filter calculation in the electronic filtering operation (i.e., a calculated value obtained as the result of the filtering operation) on the preceding frame is reused as is. It is because a difference between adjoining frames is decided to be small that the filter calculation result for the previous frame is used as is. In Embodiment 1 in particular, the filtering operation is performed on even-numbered frames (f0, f2, f4, . . . , f10) and, in odd-numbered frames (f1, f3, f5, . . . , f11), the filtering operation results of the even-numbered frames, one frame before the odd-numbered frames, are reused as is. This process reduces the amount of processing that the filtering operation is required to perform for the entire video data, so that the overall processing can be speeded up.

FIG. 2 represents the electronic watermarking operation of Embodiment 1, which includes moving image data 201, a video/voice separation unit 202, video data 203, voice data 204, an electronic watermarking operation unit 205, electronic watermarked video data 206, a video/voice combining unit 207, and watermarked moving image data 208. The electronic watermarking program in each embodiment of this invention is loaded into a processor that forms a computer hardware platform for program execution and in which it is executed to perform various processing.

The moving image data 201 is input moving image data including the video data 203 which is to be electronically watermarked. The moving image data 201 may have an MPEG format, for example. The video data 203 is a video data portion after being separated from the moving image data 201. The voice data 204 is a voice data portion after being separated from the moving image data 201. The electronic watermarked video data 206 is the video data 203 embedded with an electronic watermark. The watermarked moving image data 208 is moving image data obtained by embedding an electronic watermark into the video data 203.

The video/voice separation unit 202 is a processing unit to separate the video data 203 and the voice data 204, both contained in the moving image data 201. The video/voice combining unit 207 combines the electronic watermarked video data 206 and the voice data 204 into the watermarked moving image data 208 for output.

The electronic watermarking operation unit 205 embeds an electronic watermark (electronic watermark data) in the video data 203. The electronic watermarking operation unit 205 constitutes a major part of the electronic watermark embedding program of Embodiment 1. A configuration may be built which does not include the video/voice separation unit 202 and the video/voice combining unit 207 in the program of this invention.

The electronic watermarking program of Embodiment 1 runs on a computer that works as a platform for executing the electronic watermarking processing. According to the electronic watermarking program of Embodiment 1, the video data 203 derived from the input of the moving image data 201 is embedded with an electronic watermark. The video/voice separation unit 202 separates the moving image data 201 received into the video data 203 and the voice data 204, and the separated video data 203 is input to the electronic watermarking operation unit 205, where the video data 203 is subjected to the electronic watermark embedding processing as shown in FIG. 3. The processed data is then output as the watermarked moving image data 208.

Next, the processing performed by the electronic watermarking operation unit 205 will be explained by referring to FIG. 3. The electronic watermarking operation unit 205 successively receives frames making up the video data 203 and performs processing 301-306 on each of the frames. Each frame comprises a set of pixel data of predetermined size.

First, the filtering execution decision processing 301 decides whether or not to execute filtering processing 303 on the current frame being processed. Frames that have been determined to be subjected to the filtering processing 303 will undergo luminance data extraction processing 302, filtering processing 303 and filtering result storage processing 304. If the frame is determined not to be subjected to the filtering processing 303, a calculated value of the filtering result of a past frame will be reused for the current frame. Frames that have been determined not to be subjected to the filtering processing will not undergo the filtering processing 303 and other associated processing. Instead, filtering result reading processing 306 is executed. As a last step, electronic watermark data embedding processing 305 embeds electronic watermark data in each frame.

If the filtering execution decision processing 301 decides that the filtering processing 303 is necessary, this decision is made in two possible cases: a first case is when a filtering result is not stored in memory and the other is when a timing to execute the filtering processing 303 has come. The case where a filtering result is not stored in memory means that a filtering result has not been stored in memory by a past filtering result storage processing 304. In that case, the filtering result cannot be reused, so the filtering processing 303 needs to be activated. The case where the timing for executing the filtering processing 303 has come means that a filtering result in a past frame can be used again by taking advantage of a small frame-to-frame image difference. For example, referring to FIG. 1, this latter case applies where the frame number is even (e.g., f0, f2). The filtering execution decision processing 301 makes distinction between filtering execution target frames and filtering result reuse frames as by counting the number of input frames. The filtering execution decision processing 301 may also make a decision as by checking the type of frame and by checking a frame-to-frame difference.

For those frames determined to be subjected to the filtering processing 303, the luminance data extraction processing 302 extracts luminance data and then the filtering processing 303 is executed. A calculated value obtained as a result of the filtering processing 303 is stored in a predetermined memory location by the filtering result storage processing 304 for later reuse. This is followed by the electronic watermark data embedding processing 305 embedding electronic watermark data based on the calculated value.

Here, the filtering processing 303 is a preparatory step prior to the electronic watermark embedding processing and more specifically is image processing on a frame to determine a parameter required to calculate an electronic watermark embedding strength. The embedding strength is determined by the luminance data of the frame being processed for watermark embedding. The electronic watermark data embedding processing 305 embeds electronic watermark data in an image area of the frame based on the parameter determined by the filtering processing 303.

For those frames determined not to be subjected to the filtering processing 303, the filtering result reading processing 306 reads, for reuse, a filtering result of the previous frame that was stored in memory in advance. That is, the filtering result of the current frame is considered to be approximately the same as the filtering result of one frame before and, by using the calculated value of the filtering result, the electronic watermark data embedding processing 305 is executed as the next step. The electronic watermark data embedding processing 305 uses, as is, the calculated value of the filtering result read from memory to embed electronic watermark data in the target frame.

As described above, a frame embedded with electronic watermark data by the electronic watermarking operation unit 205 is generated and output as the electronic watermarked video data 206. The electronic watermarked video data 206 is then processed by the video/voice combining unit 207 in which it is combined with the voice data 204 to generate the watermarked moving image data 208.

The data to be processed by the electronic watermarking operation unit 205 is noncompressed video data. Thus, if the video data 203 to be input is in a compressed state, it needs to be decoded from a compressed state to a decompressed state by a decoder (not shown) arranged on an upstream side of the electronic watermarking operation unit 205 before it can be processed. Data produced by the electronic watermarking operation unit 205 is encoded from the decompressed state to the compressed state, as required, by an encoder (not shown) and output as electronic watermarked video data 206.

In the electronic watermarking operation unit 205, electronic watermark data is embedded in the frame by a predetermined electronic watermarking method. The applied electronic watermarking method itself is not given any particular limitation except that it includes the filtering processing as a precondition. The filtering execution decision processing 301 is only one example processing for electronic watermarking and other form of processing may be employed.

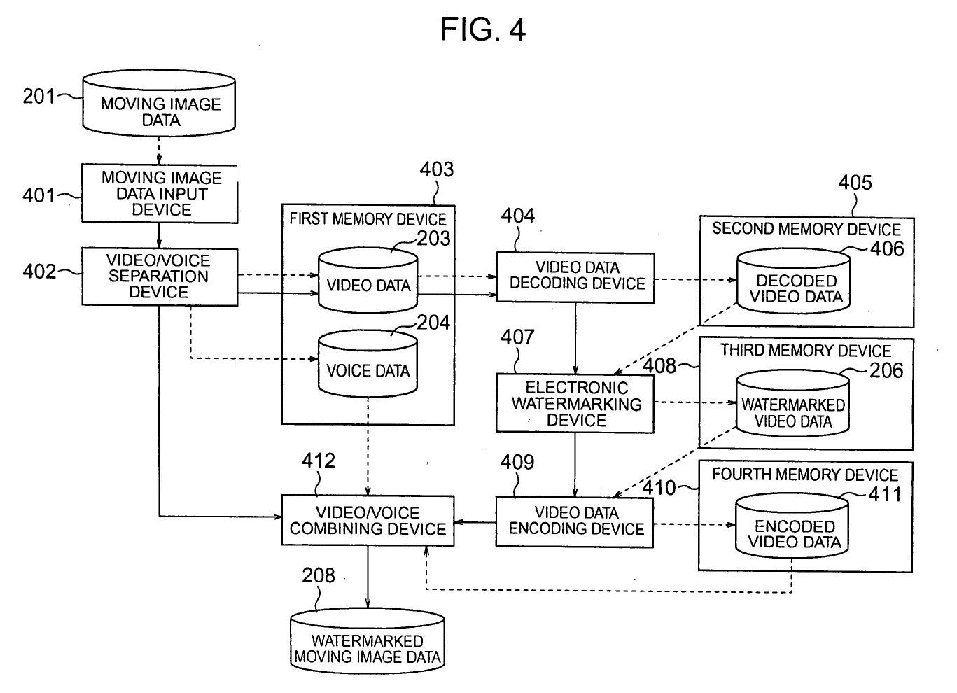

FIG. 4 is a block diagram showing an example configuration of an electronic watermarking system that executes processing corresponding to the electronic watermarking program of Embodiment 1. This system comprises a moving image data input device 401, a video/voice separation device 402, a first memory device 403, a video data decoding device 404, a second memory device 405, an electronic watermarking device 407, a third memory device 408, a video data encoding device 409, a fourth memory device 410, and a video/voice combining device 412. This system is constructed, for example, of a single electronic watermarking processor.

The moving image data input device 401 inputs the moving image data 201 from outside for processing and outputs it to the video/voice separation device 402. Processing in each device is performed on one frame at a time or in predetermined data units, such as a unit image area equal to each of divided areas of a frame. At each processing timing, data is moved in the predetermined data units.

The video/voice separation device 402 inputs the moving image data 201 from the moving image data input device 401 and separates it into the video data 203 and the voice data 204. The video/voice separation device 402 outputs the separated video data 203 to the first memory device 403 where it is temporarily stored in a video data memory area. The separated voice data 204 is output to the first memory device 403 where it is temporarily stored in a voice data memory area. The video/voice separation device 402 outputs those of the moving image data 201 that does not need to be separated (those portions not to be subjected to the electronic watermarking processing) to the video/voice combining device 412.

The video data 203 is output from the first memory device 403 to the video data decoding device 404. Also from the first memory device 403 the voice data 204 is output to the video/voice combining device 412.

The video data decoding device 404 takes in the video data 203 from the first memory device 403 and, if the video data 203 is in an encoded state, i.e., compressed state, decodes it and outputs the decoded video data (video data in the decoded state, i.e., decompressed state) 406 to the second memory device 405 where it is temporarily stored in a predetermined memory area (indicated by a dashed line in the figure). Or, if the decoded video data 406 does not need to be stored temporarily in the second memory device 405, the video data decoding device 404 outputs the decoded video data 406 to the electronic watermarking device 407 (indicated by a solid line in the figure). If the input video data 203 is in the decoded state, the video data decoding device 404 outputs the received video data 203 as is.

The electronic watermarking device 407 receives the video data in the decoded state (decoded video data 406) from the second memory device 405 or the video data decoding device 404 and performs the electronic watermarking processing (equivalent to the processing performed by the electronic watermarking operation unit 205 described earlier) on the video data. Then, the processed data or electronic watermarked video data 206 is output to the third memory device 408 where it is stored in a predetermined memory area (indicated by a dashed line in the figure). Or the electronic watermarking device 407, if the electronic watermarked video data 206 does not need to be stored temporarily, outputs it to the video data encoding device 409.

The video data encoding device 409 inputs the electronic watermarked video data 206 from the third memory device 408 or the electronic watermarking device 407 and, if the video data is in the decoded state, i.e., decompressed state, encodes it before outputting electronic watermarked, encoded video data 411 to the fourth memory device 410 where it is temporarily stored in a predetermined memory area (shown by a dashed line in the figure). Or, if the electronic watermarked, encoded video data 411 does not need to be stored temporarily, the video data encoding device 409 outputs it to the video/voice combining device 412.

The video/voice combining device 412 inputs the electronic watermarked, encoded video data 411 from the fourth memory device 410 or the video data encoding device 409, also takes in from the first memory device 403 the voice data 204 that corresponds to (synchronizes with) the video data 411, and combines the video data and the voice data. Alternatively, the video/voice combining device 412 inputs from the video/voice separation device 402 those moving image data that was not separated into video and voice. Then, the video/voice combining device 412 combines a watermarked moving image data portion that has undergone the combining processing and an unseparated moving image data portion to generate the watermarked moving image data 208, which is then output to the outside.

The above Embodiment 1 offers advantages in particular of being able to reduce the amount of filtering processing, which constitutes a part of the electronic watermarking operation, and thereby speed up an overall processing.

A variation of Embodiment 1 will be described. While in Embodiment 1 the filtering processing execution and the filtering result reuse are alternated repetitively in units of frame, the ratio between the frames subjected to the filtering processing and the frames subjected to the filtering result reuse may be otherwise. For example, according to the image difference (or closeness) between adjoining frames on a time axis, one frame to be subjected to the filtering processing may be followed by two successive frames that use filtering results. Or one filtering processing execution frame may be followed by three successive frames that reuse filtering results.

In still another example of operation, when the image difference between frames can be decided to be small, the filtering results may continue to be used. For example, a check is made of an image difference between one filtering processing frame and a filtering result reuse frame that comes next and, based on the result of this check, the number of subsequent frames that reuse the filtering result is determined.

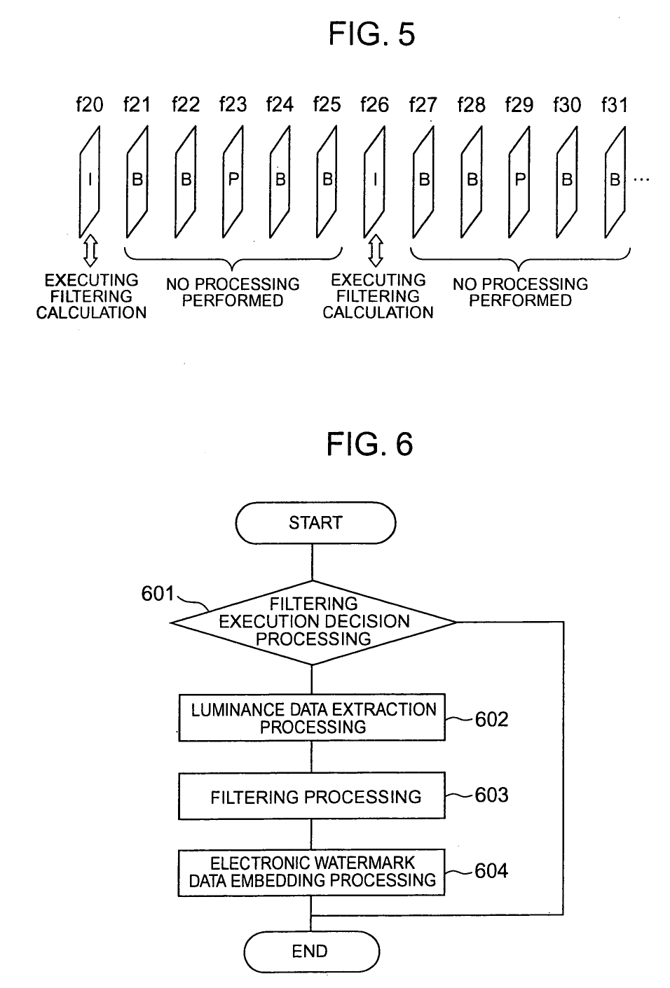

FIG. 5 is an explanatory diagram showing an outline of processing performed on video data by an electronic watermarking program in another embodiment. FIG. 6 is a flow chart showing processing performed by the electronic watermarking program in Embodiment 2 of this invention.

The electronic watermarking program of this embodiment is a program that inputs moving image data compressed by a difference compression method and embeds an electronic watermark in the video data. This program causes a computer to execute the processing which involves deciding, based on a recognized compression type (category) of the frames, whether or not the frames making up the video data should be subjected to the electronic watermarking processing and, based on this decision, performing the electronic watermarking processing on those frames that have been decided to be subjected to the electronic watermarking processing. In this decision the frames that are determined to be subjected to the electronic watermarking processing are a type of frame which has the compression of pixels in an entire image of one frame completed within that frame.

In performing the electronic watermarking processing on the moving image data applying the difference compression method (e.g., MPEG), the embedding of an electronic watermark into a type of frames which are compressed (encoded) based on frame-to-frame difference information is considered to produce little watermarking effect. That is, this type of images has a small possibility of an electronic watermark being detected and thus an advantage obtained by embedding electronic watermark data is small. For example, embedding electronic watermark data in P frames (forward prediction encoded images) and B frames (bidirectional prediction encoded images) can produce little watermarking effect.

Therefore, only the frames which have the encoding completed within each frame (e.g., I frame (intraframe encoded images) in MPEG), not based on frame-to-frame difference information, or those which have a small percentage of encoding based on frame-to-frame difference information are determined to be subjected to the electronic watermarking processing. And the electronic watermarking processing, including the filtering processing and the electronic watermark data embedding processing, is performed on these frames. Other frames, i.e., those compressed based on the frame-to-frame difference information, or those having a high percentage of encoding based on frame-to-frame difference information, are excluded from the electronic watermarking processing.

In FIG. 5, reference numbers f20-f31 refer to frame numbers of frames consecutive on a time axis that make up video data. In Embodiment 2, the electronic watermarking processing is executed on moving image data that is compressed (encoded) based on the difference compression method, such as MPEG. In that case, a type of compression (encoding) of each frame making up the video data is checked and, based on the result of this check, a decision is made as to whether the frame of interest requires the electronic watermarking processing. In this decision, the frames encoded based on intraframe image information (e.g., 1 frame in the case of MPEG), not on interframe difference information, are determined to be subjected to the electronic watermarking processing and those which base their encoding on interframe difference information (e.g., P frames and B frames in the case of MPEG) are determined not to be subjected to the electronic watermarking processing. According to this decision, the electronic watermarking processing is executed only on that type of frames whose encoding is completed based on intraframe image information. In the case of FIG. 5, frames of frame number f20 and f26 are I frames and therefore they are determined to be objects for the electronic watermarking processing and then undergo that processing. Other frames are P frames and B frames and they are determined not to be subjected to the electronic watermarking processing. Nor are they subjected to the filtering processing. This reduces the amount of electronic watermarking processing, thus speeding up the overall processing on the entire moving images.

In MPEG, when images of frames (pictures) are encoded, the individual frames are distinguished into three types, I frames, P frames and B frames, and a prediction encoding is performed between the frames. The I frames are encoded independently of other types of frames and are images whose encoding is completed within each frame. The I frames constitute a prediction reference frame for P frames and B frames. Since they use the interframe difference information, the I frames have the largest data quantity. The P frames are forward prediction-encoded images which are prediction-encoded by using a past frame on the time axis. The B frames are bidirectional prediction-encoded images which are prediction-encoded in both directions by using past and future frames on the time axis. The B frames has the least amount of data.

The data input/output associated with the electronic watermarking program of Embodiment 2 and the outline processing of the program are similar to those of FIG. 2. Of the moving image data 201 the video data 203 is data encoded by the difference compression method. The frames making up the video data 203 are entered into the electronic watermarking operation unit 205. In Embodiment 2, the electronic watermarking operation unit 205 performs processing as shown in FIG. 6.

Referring to FIG. 6, how the electronic watermarking operation unit 205 in Embodiment 2 performs will be explained. The electronic watermarking operation unit 205 successively inputs the frames making up the video data 203 and performs processing 601-604 on each frame. The data to be processed by the electronic watermarking operation unit 205 is noncompressed video data. Since the input video data 203 is compressed data, it is decoded from the compressed state to a decompressed state, as required, by a decoder upstream of the electronic watermarking operation unit 205. Data output from the electronic watermarking operation unit 205 is encoded from the decompressed to the compressed state by an encoder downstream of the electronic watermarking operation unit 205 to produce the electronic watermarked video data 206.

First, filtering execution decision processing 601 makes a decision as to whether filtering processing 603 should be executed on a current frame, i.e., whether the current frame should be subjected to the electronic watermarking processing. A factor that leads to a decision that the filtering processing 603 needs to be executed will be explained by taking up an example case where data of MPEG-1 format is input as video data 203 highly compressed by the difference compression method.

Data of MPEG-1 format can be classified into frames (I frames) whose compression (encoding) processing covers pixels in the entire image of each frame and frames (P frames and B frames) whose compression processing covers information on difference from past frames or from past and future frames. If the frame type can be classified as described above, the information contained in the frame that is compressed using the frame-to-frame difference information can be considered to be infinitesimally small. That is, because there is little possibility that the electronic watermark can be detected, the advantage of executing the electronic watermarking processing can be decided to be small.

Thus, the filtering execution decision processing 601 forward-reads the encoder decisions on the frame type and decides that the filtering processing 603 needs to be executed only when I frames are input. The check on the frame type and on the interframe difference may be done by either the encoder or the filtering execution decision processing 601.

For the frame which is determined as requiring the filtering processing 603, luminance data extraction processing 602 extracts luminance data and the filtering processing 603 is executed. Then, electronic watermark data embedding processing 604 embeds electronic watermark data in the current frame based on the calculated value obtained by the filtering processing 603.

The frame which is determined as not requiring the execution of the filtering processing 603 is not subjected to the electronic watermarking processing and the program is ended without performing processing on the frame.

As described above, the electronic watermarking operation unit 205 generates a frame embedded with electronic watermark data, which is output as electronic watermarked video data 206. The electronic watermarked video data 206 is subjected to the video/voice combining processing by the video/voice combining unit 207 in which it is combined with the voice data 204 to produce watermarked moving image data 208.

The configuration of the electronic watermarking system that executes processing corresponding to the electronic watermarking program of Embodiment 2 is similar to FIG. 4. This configuration differs from FIG. 4 in that the electronic watermarking device 407 performs processing shown in FIG. 6.

In the case of Embodiment 2 also, the electronic watermarking method applied to the electronic watermarking operation unit 205 is not itself limited in any way except that it includes the filtering processing.

Embodiment 2 described above offers a particular advantage of being able to reduce the amount of electronic watermarking processing and thereby speed up the overall processing.

(Embodiment 3)

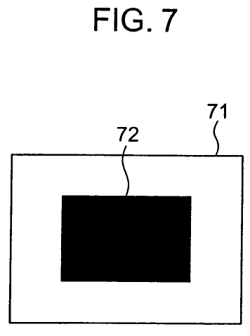

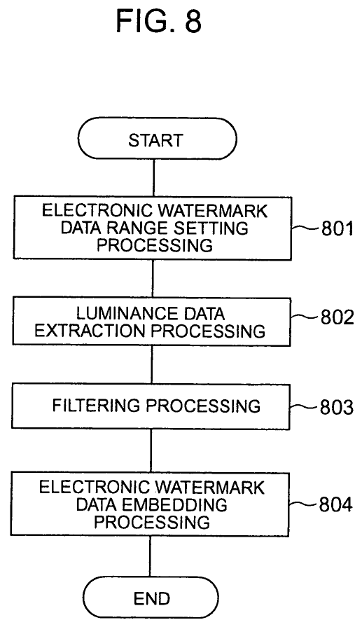

FIG. 7 is an explanatory diagram showing an outline of processing performed on video data by the electronic watermarking program according to Embodiment 3 of this invention. FIG. 8 is a flow chart showing processing performed by the electronic watermarking program of Embodiment 3 of this invention.

The electronic watermarking program of this embodiment is a program that inputs moving image data and embeds an electronic watermark in its video data. In embedding an electronic watermark in frames making up the video data, the program causes a computer to execute processing which involves making a setting to limit a range covered by the electronic watermarking processing to a part of the entire image of each frame and executing the electronic watermarking processing on the frames according to the setting.

In FIG. 7, a frame 71 represents one of the frames making up the video data, i.e., an entire image area of the frame. An electronic watermark data embedding range 72 represents an example range in the image area of the frame 71 which is subjected to the electronic watermarking processing.

In Embodiment 3, a range covered by the electronic watermarking processing is limited to a part of an image area forming each of the frames that make up the video data. In executing the electronic watermarking processing on moving image data, the electronic watermark data embedding range 72 is set for each frame making up the video data. This setting may be a predetermined range or may be set for each frame as it is processed. Then, the electronic watermarking processing including the filtering processing is executed on this electronic watermark data embedding range 72. In the case of FIG. 7, the electronic watermark data embedding range 72 is limited to a predetermined size of a rectangular image range in the frame.

The data input/output associated with the electronic watermarking program of Embodiment 3 and an outline of its processing are similar to those of FIG. 2. Frames comprising the video data 203 are entered into the electronic watermarking operation unit 205. In Embodiment 3, the electronic watermarking operation unit 205 performs processing as shown in FIG. 8.

Referring to FIG. 8, the processing performed by the electronic watermarking operation unit 205 according to Embodiment 3 will be explained. The electronic watermarking operation unit 205 successively inputs frames making up the video data 203 and performs processing 801-804 on each frame. The data to be processed by the electronic watermarking operation unit 205 is noncompressed video data. So, the video data 203 is either decoded or encoded, as required, by decoder or encoder.

In the electronic watermarking operation unit 205, first, electronic watermark data range setting processing 801 sets a predetermined electronic watermark data embedding range 72 in the frames to be processed. Then, luminance data extraction processing 802 collects luminance information for the electronic watermark data embedding range 72 set for the frames to be processed and executes the filtering processing 603. After this, electronic watermark data embedding processing 804 embeds electronic watermark data only in the electronic watermark data embedding range 72 based on the calculated value obtained by the filtering processing 803.

Further, the electronic watermark data range setting processing 801 also performs related processing, which involves, for example, storing in a predetermined memory a parameter value for setting the electronic watermark data embedding range 72 and reading it, as required, to perform the setting on the frames. Alternatively, the electronic watermark data range setting processing 801 may check the type of frame and set the electronic watermark data embedding range 72 accordingly.

It is also possible to adopt a configuration in which the electronic watermark data range setting processing 801 first decides whether or not to set the electronic watermark data embedding range 72 before actually making the range setting. That is, the electronic watermark data embedding range 72 is set for only some of the frames making up the video data 203. It is also noted that the electronic watermark data embedding range 72 is not limited to a rectangular area.

As described above, the electronic watermarking operation unit 205 generates frames embedded with electronic watermark data and outputs the watermarked frames as the electronic watermarked video data 206. The electronic watermarked video data 206 is then combined with the voice data 204 by the video/voice combining unit 207 to generate the watermarked moving image data 208.

The configuration of the electronic watermarking system that executes processing corresponding to the electronic watermarking program of Embodiment 3 is similar to FIG. 4. This configuration differs from FIG. 4 in that the electronic watermarking device 407 performs processing shown in FIG. 8.

In this embodiment also, the electronic watermarking method applied to the electronic watermarking operation unit 205 is not itself limited in any way except that it includes the filtering processing and that the watermarking processing is performed in the electronic watermark data embedding range 72.

In the frames making up the video data, the range covered by the electronic watermarking processing is limited to a part of the entire image area forming each frame. For example, the processing range is restricted to a predetermined size of a rectangular pixel area in each frame. Limiting the electronic watermark data embedding range can reduce the amount of electronic watermarking processing and thereby enhance the overall processing speed.

While the application to the moving image data of even one of the processing speedup provisions offered by the above embodiments can be expected to produce its effect, a combination of two or more speedup provisions will produce a greater effect. For example, Embodiment 1 and Embodiment 3 may be combined. In that case, the area in the frames to be processed is limited by the electronic watermark data embedding range 72 and the filtering processing or the filtering result reuse processing is executed as the electronic watermarking processing on the limited area. It is also possible to combine Embodiment 2 and Embodiment 3. In that case, the following processing may be performed. In the frames that are compressed by using intraframe image pixels, the area to be processed is limited by the electronic watermark data embedding range 72 and the electronic watermarking processing is executed on the limited area in these frames.

The processing to detect the watermark embedded by the electronic watermarking program of the above embodiments conforms to the conventional technology.

With the configurations of the above embodiments, performance improvements of the processing for embedding electronic watermarks in moving image data and processing time reductions can be realized at low cost. Furthermore, the implementation of the processing for embedding electronic watermarks in moving image data can be made feasible even on a platform with limited hardware resources.

Although the present invention has been described in detail by taking up example embodiments, it should be noted that the invention is not limited to the embodiments disclosed but is capable of numerous modifications and changes without departing from the spirit of the invention.

1. An electronic watermarking method for embedding an electronic watermark in video data made up of a plurality of frames, comprising:
a first step of executing filtering processing on the plurality of frames by omitting a part of the frames in terms of time or space, the filtering processing being intended to embed an electronic watermark; and
a second step of executing the electronic watermarking processing on a portion subjected to the filtering processing by using a result of the filtering processing executed in step 1

2. An electronic watermarking method according to claim 1, further comprising:
a third step of executing, on a portion that was not subjected to the filtering processing, the electronic watermarking processing by using the result of the filtering processing executed in the first step.

3. An electronic watermarking method according to claim 2, wherein in the first step the filtering processing is executed on alternate ones of the plurality of frames, and
in the second step the result of the filtering processing executed on a previous frame is used for the frames that are not subjected to the filtering processing.

4. An electronic watermarking method according to claim 2, wherein in the first step the filtering processing is executed on one frame, and
in the second step an electronic watermark is embedded in frames by applying the result of the filtering processing to at least one frame following the one frame in terms of time.

5. An electronic watermarking method according to claim 1, further comprising a third step of, when the video data to be watermarked is MPEG compressed data, decoding the video data;
wherein in the first step the filtering processing is executed on I frames.

6. An electronic watermarking method according to claim 1, wherein in the first step the filtering processing is executed on a part of each of the plurality of frames; and
in the second step an electronic watermark is embedded in a part of each frame by using a result of the filtering processing.

7. An electronic watermarking method according to claim 1, wherein in the first step the filtering processing is executed, based on luminance information on a part of the frame to be processed.

8. An electronic watermarking method for embedding an electronic watermark in video data contained in moving image data taken in, the electronic watermarking method comprising:
a first step of deciding whether or not to execute filtering processing for electronic watermarking on one frame of the video data;
a second step of, based on the decision of the first step, executing the filtering processing on the frame to be subjected to the filtering processing;
a third step of storing a result of the filtering processing; and
a fourth step of executing the electronic watermarking processing on a frame to be subjected to the filtering processing by using the result of the filtering processing.

9. An electronic watermarking method according to claim 8, further comprising a fifth step of, based on the decision of the first step, executing the electronic watermarking processing on a frame not to be subjected to the filtering processing by using the stored result of the filtering processing.

10. An electronic watermarking method according to claim 8, in the first step either an odd-numbered frame or even-numbered frame is decided to be subjected to the filtering processing for electronic watermarking.

11. An electronic watermarking method according to claim 10, further comprising:
a step executed when the moving image data is MPEG data;
wherein in the first step I frames are decided to be subjected to the filtering processing for electronic watermarking.

12. An electronic watermarking method according to claim 11, wherein in the fourth step the result of the filtering processing on the I frames is applied to the electronic watermarking processing on P frames.

13. A storage medium for storing an electronic watermarking program, wherein the electronic watermarking program embeds an electronic watermark in video data contained in moving image data taken in, the electronic watermarking program comprising:
a first step of deciding whether or not to execute filtering processing for electronic watermarking on one frame of the video data;
a second step of, based on the decision of the first step, executing the filtering processing on the frame to be subjected to the filtering processing;
a third step of storing a result of the filtering processing; and
a fourth step of executing the electronic watermarking processing on a frame to be subjected to the filtering processing by using the result of the filtering processing.

14. A storage medium for storing an electronic watermarking program according to claim 13, wherein the program further comprises a fifth step of, based on the decision of the first step, executing the electronic watermarking processing on a frame not to be subjected to the filtering processing by using the stored result of the filtering processing.

15. A storage medium for storing an electronic watermarking program according to claim 13, wherein in the first step either an odd-numbered frame or even-numbered frame is decided to be subjected to the filtering processing for electronic watermarking.

16. A storage medium for storing an electronic watermarking program according to claim 15, further comprising:
a step executed when the moving image data is MPEG data;
wherein in the first step I frames are decided to be subjected to the filtering processing for electronic watermarking.

17. A storage medium for storing an electronic watermarking program according to claim 16, wherein in the fourth step the result of the filtering processing on the I frames is applied to the electronic watermarking processing on P frames.

18. An electronic watermarking method according to claim 11, wherein in the fourth step the result of the filtering processing on the I frames is applied to the electronic watermarking processing on B frames.

19. An electronic watermarking method according to claim 11, wherein in the fourth step the result of the filtering processing on the I frames is applied to the electronic watermarking processing on P frames and B frames.

20. A storage medium for storing an electronic watermarking program according to claim 16, wherein in the fourth step the result of the filtering processing on the I frames is applied to the electronic watermarking processing on B frames.

21. A storage medium for storing an electronic watermarking program according to claim 16, wherein in the fourth step the result of the filtering processing on the I frames is applied to the electronic watermarking processing on P frames and B frames.
